(19) United States
(12) Patent Application Publication
(10) Pub. No.: US 2009/0012740 A1
(43) Pub. Date: Jan. 8, 2009

(54) Method for determining the wheel position in a vehicle

(76) Inventors: Mathias Hain, Reutlingen (DE); Nikolaos Oikonomidis, Leinfelden-Echterdingen (DE)

Correspondence Address: KENYON & KENYON LLP, ONE BROADWAY, NEW YORK, NY, 10004, US

(21) Appl. No.: 12/157,678

(22) Filed: Jun. 11, 2008

(30) Foreign Application Priority Data
Jun. 21, 2007 (DE) 102007028518.5

(51) Int. Cl. G01P 3/44

(52) U.S. Cl. 702/148

(57) ABSTRACT

In a method for determining the wheel position in a vehicle, phase-shifted sensor signals of one wheel are evaluated, the position of the wheel on the left or right side of the vehicle being ascertained based on the algebraic sign of the phase shift.

### BACKGROUND INFORMATION

A method is described in German Patent No. DE 10 2005 022 287. This citation describes that, in a tire-pressure module which is integrated into the tire of a wheel, in addition to providing a pressure sensor for measuring the tire inflation pressure, to provide two acceleration sensors which record accelerations in the radial direction and the circumferential direction, respectively, so that the signals supplied by the acceleration sensors are out of phase by 90° relative to each other. The position of the wheel in question in the left or right side area of the vehicle may be inferred in a regulating or control unit, based on the phase difference between the sensor signals. This information is important for assigning the suitable pressure value to the tire.

### SUMMARY OF THE INVENTION

An object of the present invention is to automatically provide information in a vehicle about the wheel position in the left or right vehicle area using simple measures and with great reliability.

This objective is achieved according to the present invention.

The method of the present invention is used for automatically determining whether a sensor signal is coming from a wheel in the right or the left side area. The automatic assignment of the sensor signal to the left or the right vehicle wheel is thereby also possible during running operation, and, for example, may be taken into account accordingly in an electronic stability program. At least two sensor signals per wheel that are out of phase relative to each other are requisite for implementing the method. The position of the wheel either on the left or on the right side of the vehicle may be deduced from the direction of the phase shift. In this connection, use is made of the fact that for reasons of cost and simplification, wheels are set up identically with the same arrangement and positioning of acceleration sensors, regardless of whether they are installed in the right or left side area of the vehicle, the arrangement in mirror symmetry with respect to the longitudinal axis of the vehicle leading to either a positive or negative phase shift between the signals of the sensors of a wheel. This phase shift is utilized or evaluated as information about the position of the wheel in the left or in the right side area of the vehicle.

In this context, the direction of the vehicle movement must be taken into consideration. For this reason, prior to—possibly also after—the evaluation of the phase-shifted signals, the direction of movement of the vehicle is expediently determined, thus, it is established whether the vehicle is moving forward or backward. Depending on the direction of movement, the phase shift between the sensor signals of a wheel lies in the positive or in the negative area, from which it is possible to deduce the left or the right side area of the vehicle.

Moreover, before evaluating the sensor signals to determine the wheel position, it is advantageous to first determine the offset of each sensor signal which denotes the deviation of the signal mean value with respect to the x-axis about which the sensor signals sinusoidally oscillate. To be able to relate the sensor signals to each other, the signal values must first be corrected by this offset in order to rule out a signal falsification and an incorrect determination of the wheel position possibly resulting therefrom. The offset is resolved by shifting the mean value about which the signals of each acceleration sensor sinusoidally oscillate, to zero.

To determine the wheel position, a plurality of sampling points of each sensor, thus a plurality of sensor signals at instants coming shortly after each other, are ascertained and are related to each other. At least two sensor signals of each sensor must be determined per wheel revolution. In so doing, the signals of the first and the second sensor per wheel are ascertained at the same instants, in order to be able to produce a meaningful relationship between the signal patterns.

Expediently, only sensor signals from a stipulated time segment are utilized for evaluation, the time segment in question being defined in particular by the presence of certain conditions between the signal values. This at least one time segment—or the corresponding rotational-angle segment—per wheel revolution is advantageously characterized in that the at least two signal patterns per wheel do not intersect within this segment. This ensures that predefined conditions with respect to the proportion in size of the sampling points of different sensors may be satisfied unambiguously. It has proven to be useful to assign at least two time segments or rotational-angle segments per wheel revolution, which in each case are taken into consideration for identifying the position of the wheel concerned.

The gradient of the two sensors in the segment considered may be taken into account as a further condition; in doing so, advantageously as the condition to be satisfied, the gradients of both sensors, thus the slope between successive sampling points, must in each case be either rising or falling. This condition ensures that the signal patterns of the two sensors still have a sufficiently large distance to their intersection.

It is advantageous that sensor signals are generated continually, but are evaluated only if the stipulated conditions are satisfied, and otherwise are disregarded.

### BRIEF DESCRIPTION OF THE DRAWINGS

FIG. 1 shows a schematic representation of a vehicle having two acceleration sensors per wheel whose signals are evaluated in a central regulating or control unit.

FIG. 2 shows a diagram having the pattern of the signals of the two acceleration sensors in one side area of the vehicle.

FIG. 3 shows a representation of sensor signals corresponding to FIG. 2, however of sensors of a wheel from the opposite side area of the vehicle.

FIG. 4 shows a flow chart having the individual method steps for determining the wheel position in a vehicle.

### DETAILED DESCRIPTION

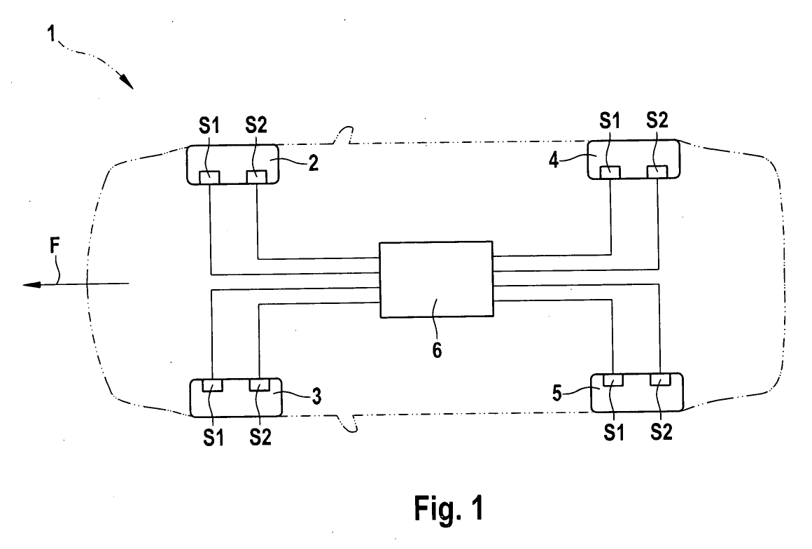

FIG. 1 shows a highly schematized representation of a motor vehicle 1 having wheels 2, 3, 4 and 5 in the front left, front right, rear left and rear right side areas of the vehicle. The foreword direction of the vehicle is denoted by F. Each vehicle wheel 2, 3, 4, 5 is equipped with two acceleration sensors S1, S2, whose sensor signals are conducted to a central regulating or control unit 6 for further evaluation. A design having only one acceleration sensor per wheel is also possible, the acceleration sensor having two different detection axes. The measuring directions of acceleration sensors S1, S2 are angularly offset relative to each other at each wheel, so that acceleration sensors S1, S2 supply signals that are phase-shifted relative to each other. The signal pattern of each sensor S1, S2 is sinusoidal; accordingly, the sinusoidal signal patterns of sensors S1 and S2 of one respective wheel also exhibit a phase shift relative to each other which corresponds to the angular offset between the two sensors, that is, between the measuring directions of the sensors. For example, if the angular offset at a wheel is 90°, then the phase shift between the signal patterns is also 90°. The acceleration sensors are expediently integrated into a tire-pressure module, which is inserted into each wheel.

The wheels at least in the front side area left and right or in the rear side area left and right are set up identically to one another, and have the same acceleration sensors in the same arrangement in each instance. This results in a mirror-symmetric arrangement of the wheels and the sensors in the front left and right or rear left and right side areas of the vehicle. Consequently, the sensor signals of the wheels in the left side area in comparison to the sensor signals of the wheels from the right side area are also shifted by a positive or negative phase angle relative to each other. Therefore, based on the algebraic sign of the phase shift of the sensor signals of a wheel, it is possible to infer the position either in the left or in the right side area of the vehicle. The phase shift of +−90°, for example, is advantageously transformed into a normalized phase relation of +−1, different algebraic signs of the phase relation representing opposite directions of travel.

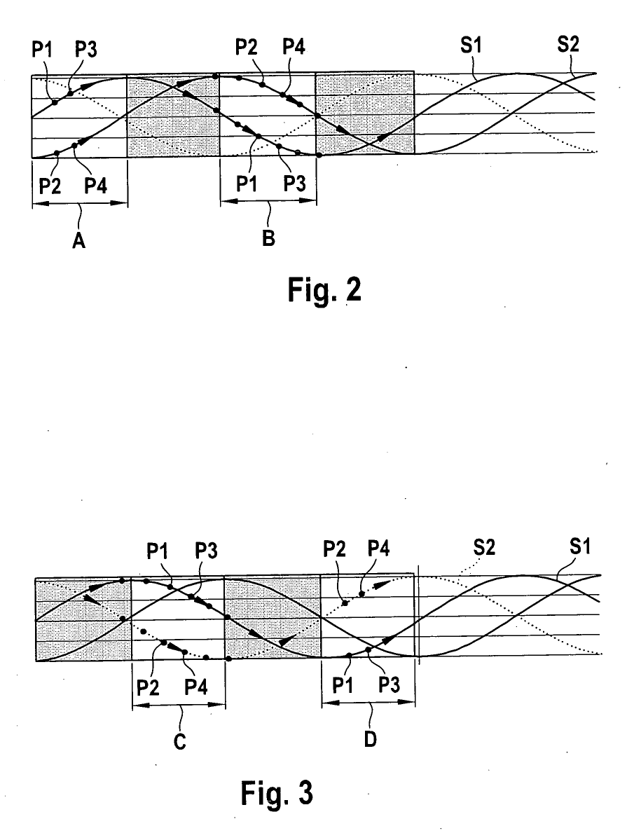

FIGS. 2 and 3 show diagrams having the sinusoidal signal patterns of the acceleration sensors of, in each case, one wheel, FIG. 2 being assigned to a wheel from the left side area, for example, and FIG. 3 being assigned to a wheel from the right side area. The sensor-signal patterns are out of phase by an angle amount of 90° relative to each other, the phase shift between S1 and S2 in the first case (FIG. 2) being positive, and in the second case (FIG. 3) being negative. To determine the wheel position in the left or right side area of the vehicle, sampling points P1, P2, P3, P4 of the sensors are determined, which represent individual sensor signals at specific instants. Considered in each case are the sampling points at two instants or rotational-angle positions shortly following each other within one revolution of the wheel. At a first instant or a first rotational-angle position, sampling points P1 and P2 of sensors S1 and S2, respectively, are determined; at an instant or a rotational-angle position shortly following, sampling points P3 and P4 of sensors S1 and S2 are determined. Only defined time segments or rotational-angle segments which are denoted by A and B in FIG. 2 and by C and D in FIG. 3 are taken into account; in these areas, sampling points P1 through P4 satisfy stipulated relationships, from which it is possible to deduce the wheel position in the left or right vehicle area.

For segment A, the pattern of the signals of first sensor S1 lies above the signals of second sensor S2; at the same time, both signal patterns have a rising gradient. Accordingly, the value of sampling point P1 is greater than the value of sampling point P2 at the first instant considered within segment A, and the value P3 of sensor S1 is greater than P4 of sensor S2 at the second instant considered within segment A. In addition, the pattern of sensor signal S1 lies above that of sensor signal S2, so that P1 is less than P3, and P2 is less than P4.

Following segment A is a segment denoted in gray, in which the curve patterns of S1 and S2 intersect. This segment denoted in gray is not utilized for determining the wheel position.

Following it is a further segment B which is suitable for determining the wheel position. In segment B, the signal pattern of S2 lies above signal pattern S1; both signal patterns exhibit a falling gradient in this segment. Accordingly, sampling point P2 at the first instant considered within segment B lies above P1, and P4 at the second instant considered within segment B lies above P3. In addition, as gradient condition, P2 is greater than P4, and P1 is greater than P3.

Following segment B is a further segment denoted in gray, in which the two curve patterns of S1 and S2 intersect; this further segment denoted in gray is not taken into consideration.

For example, the curve pattern according to FIG. 2 characterizes a vehicle wheel in the left side area of the vehicle. Only the sampling instants within segments A and B are taken into account. If the indicated relationships between at least the four sampling points P1 through P4, thus, in each case two sensor signals per sensor, as described above are satisfied in segments A or B, the position of the vehicle wheel in the left side area of the vehicle may be inferred in the regulating or control unit.

FIG. 3 shows a corresponding representation of the curve pattern of the two sensor signals S1 and S2 for a vehicle wheel from the opposite side area of the vehicle, thus, e.g., from the right side area of the vehicle. Sensor signals S1 and S2 have an opposite phase shift compared to FIG. 2. To determine the wheel position, again only those segments are considered in which the sinusoidal curve patterns do not overlap; these segments are denoted by C and D. The remaining segments are denoted in gray; in these segments, the curves intersect, so that no unambiguous determination is possible.

At the same time, however, the conditions within segments C and D differ from those of segments A and B, so that a clear differentiation is possible between left and right wheel. In segment C, the curve pattern of first sensor S1 lies above the sensor pattern of S2; however, both sensor patterns have a falling gradient. Accordingly, sampling point P1 at the first considered instant of segment C is greater than P2, and P3 at the second considered instant shortly following within segment C is greater than P4. Furthermore, P1 is greater than P3, and P2 is greater than P4. In sum, these conditions differ from those of segments A and B from the opposite side area of the vehicle.

In further segment D, which likewise may be utilized for the evaluation, the pattern of first sensor S1 lies below the pattern of second sensor S2; at the same time, both sensor-signal patterns exhibit a rising gradient. This means that at the first considered instant of segment D, sampling point P2 lies above sampling point P1, and at the second instant considered, P4 lies above P3. At the same time, P2 is less than P4, and P1 is less than P3.

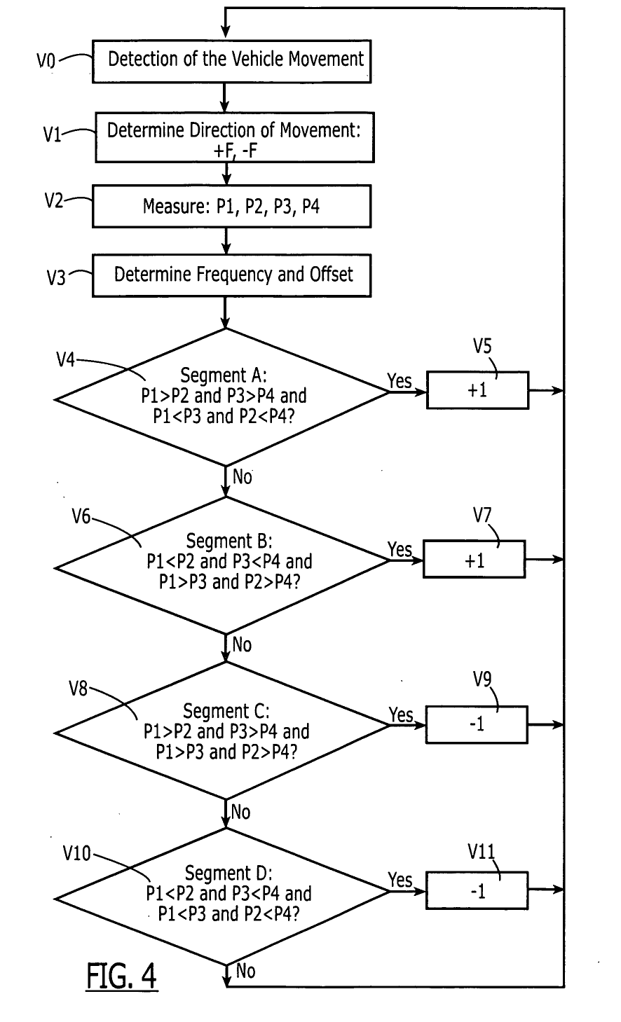

FIG. 4 shows, by way of example, a flowchart having the individual method steps for determining the wheel position in a vehicle. In alternative methods falling under the present invention, individual method steps may be interchanged or omitted.

First of all, at the beginning of the method in method step V0, it is determined whether the vehicle has been set in motion. In the next method step V1, the direction in which the vehicle is moving is determined, +F standing for driving forward and −F standing for driving in reverse. In the following method step V2, a plurality of sampling points P1 through P4 of the acceleration sensors of one wheel are determined, which in the following method step V3, are evaluated in a regulating or control unit. If necessary, by measuring further measuring points, it is possible to determine the frequency of each sensor pattern, from which the wheel rotational speed may also be inferred. This measurement permits a new balancing of the offset and the optimization of the sampling times, the offset denoting the mean position about which the sensor pattern sinusoidally oscillates. This offset may be reduced to zero by calculation, in order to permit the comparison of sinusoidal signal patterns of different sensors to one another.

In the following method steps V4, V6, V8 and V10, various conditions, which correspond to segments A, B, C and D from FIGS. 2 and 3 described above, are in each instance checked cumulatively. If these conditions are satisfied, it is possible to definitively conclude the position of a wheel either in the left or in the right side area of the vehicle. This is accomplished in the control unit by normalizing the phase relation to +1 or −1, taking the driving-direction information into account. For example, a phase relation of +1 in the case of forward driving corresponds to a position of the wheel in the left vehicle area, and a phase relation of −1 in the case of forward driving corresponds to a position of the wheel in the right vehicle area.

According to method step V4, which corresponds to segment A, it is checked whether P1 is greater than P2, P3 is greater than P4, P1 is less than P3 and P2 is less than P4. If all these conditions are satisfied cumulatively, according to the yes-branching, the method continues to method step V5, and the normalized phase relation is set to +1. After that, it is possible to return to method step V1 and, if necessary, to begin the entire method from the top.

If at least one of the conditions from method step V4 is not satisfied, according to the no-branching, the method continues to the next method step V6, in which the conditions for segment B are checked. According to segment B, P1 must be less than P2, P3 must be less than P4, P1 must be greater than P3 and P2 must be greater than P4. If all these conditions apply, according to the yes-branching, the method continues to method step V7 where, analogous to method step V5, the normalized phase relation is set to +1. Thereupon, the method may be terminated, or there may be a return again to the beginning of the method.

If one of the conditions from method step V6 is not satisfied, following the no-branching, the method continues to method step V8, and the conditions from segment C are checked. According to these conditions, P1 must be greater than P2, P3 must be greater than P4, P1 must be greater than P3 and P2 must be greater than P4. If these are all satisfied, following the yes-branching, the method continues to method step V9, and the normalized phase relation is set to −1. Otherwise, following the no-branching, the method continues to method step V10, in which the conditions for segment D are checked. In the case of these conditions, P1 must be less than P2, P3 must be less than P4, P1 must be less than P3 and P2 must be less than P4. If these conditions are satisfied, following the yes-branching, the method continues to method step V11 and the normalized phase relation is likewise set to −1. Otherwise, following the no-branching, the method is continued and is either terminated or there is a return again to the beginning of the entire method sequence.

What is claimed is:

1. A method for determining a wheel position in a vehicle, at least two wheels located in a left side area and a right side area of the vehicle being provided with at least first and second acceleration sensors with which a sensor signal may be generated upon rotation of the wheel, at least two sensor signals out of phase relative to each other being generated per wheel, the method comprising:
with respect to a wheel, determining at least two sampling points at a first instant and at least two sampling points at a following second instant, both of the first sensor and of the second sensor of a wheel;
relating the sampling points to each other to determine a phase shift; and
ascertaining the position of the wheel on the left side or the right side of the vehicle based on an algebraic sign of the phase shift.

2. The method according to claim 1, further comprising:
determining a direction of movement of the vehicle; and
assigning a stipulated phase shift in each instance to forward driving and to reverse driving.

3. The method according to claim 1, wherein the sensor signals are generated by one two-axis acceleration sensor or two single-axis acceleration sensors per wheel.

4. The method according to claim 1, wherein the sensor signals are out of phase by 90° relative to each other.

5. The method according to claim 1, wherein to determine the wheel position, only time segments or rotational-angle segments are considered in which the sampling points of the first sensor lie exclusively higher or exclusively lower than the sampling points of the second sensor.

6. The method according to claim 1, wherein a gradient between two sampling points of one of the sensors is taken into account.

7. The method according to claim 6, wherein to determine the wheel position, only time segments or rotational-angle segments are considered in which the gradients of both sensors are in each instance either rising or falling.

8. The method according to claim 1, wherein to determine the wheel position of a wheel, only at least one defined time segment or rotational-angle segment in which the sampling points satisfy stipulated conditions is taken into consideration per wheel revolution.

9. The method according to claim 8, wherein each wheel is assigned two time segments or rotational-angle segments which, in each case, are to be considered for identifying the wheel.

10. The method according to claim 1, further comprising, prior to determining the phase shift, ascertaining a plurality of sampling points for each sensor, and from them, determining a frequency and an offset.

11. A regulating/control unit for determining a wheel position in a vehicle, at least two wheels located in a left side area and a right side area of the vehicle being provided with at least first and second acceleration sensors with which a sensor signal may be generated per wheel, the unit comprising at least one arrangement for performing the following:
with respect to a wheel, determining at least two sampling points at a first instant and at least two sampling points at a following second instant, both of the first sensor and of the second sensor of a wheel;
relating the sampling points to each other to determine a phase shift; and
ascertaining the position of the wheel on the left side or the right side of the vehicle based on an algebraic sign of the phase shift.
